(19) United States
(12) Patent Application Publication
(10) Pub. No.: US 2008/0152145 A1
(43) Pub. Date: Jun. 26, 2008

(54) ASSET BRING-OUT MANAGEMENT SYSTEM, ASSET BRING-OUT MANAGEMENT METHOD, BROUGHT OUT ASSET, BROUGHT OUT ASSET CONTROL PROGRAM

(76) Inventor: NOBUO FUJIOKA, Tokyo (JP)

Correspondence Address: NEC CORPORATION OF AMERICA, 6535 N. STATE HWY 161, IRVING, TX, 75039, US

(21) Appl. No.: 11/960,204

(22) Filed: Dec. 19, 2007

(30) Foreign Application Priority Data
Dec. 25, 2006 (JP) 347932/2006

(51) Int. Cl. H04L 9/08; G06F 12/14; G06F 15/16; G08B 29/04

(52) U.S. Cl. 380/277; 713/189; 726/35; 709/202

(57) ABSTRACT

An asset bring-out management system includes a brought out asset, a managing system, an encryption determining unit, and a brought out information registering unit. The managing system manages bring-out of the brought out asset to the outside of a management area. The encryption determining unit determines whether or not encryption processing has been executed on the brought out asset. The brought out information registering unit registers brought out asset information in the managing system if the encryption processing has been executed on the brought out asset.

This application is based upon and claims the benefit of priority from Japanese patent application No. 2006-347932, filed on Dec. 25, 2006 the disclosure of which is incorporated herein in its entirety by reference.

### BACKGROUND OF THE INVENTION

1. Field of the Invention

The present invention relates to an asset bring-out management system, an asset bring-out management method, a brought out asset, and a brought out asset control program.

2. Description of the Related Art

Many companies retain personal information such as customer information, for example. To protect the personal information, these companies must take measures for security to prevent information leakage, and supervise the employees as necessary. In addition to the personal information, the companies retain important and confidential information such as information of new products. If such information is leaked to a third party, a company seriously loses confidence in society, thereby suffering great damage.

For example, if an employee brings out a notebook PC to the outside of the company and the PC is stolen, the information may be leaked. Particularly, assume that after someone downloads an encrypted file from a server in which confidential information is protected by encryption to a desktop PC, the person decodes the file and writes it into a USB memory, for example. When the decoded file is inputted from the USB memory to the notebook PC, the information may be leaked if the notebook PC is brought to the outside of the company and stolen.

Japanese Patent Laid-Open NO. 2001-266261/2003-173478/2003-296533/2006-092431/2006-107308 disclose examples of a bring-out monitoring system to judge whether or not bring-out of an article, etc. is improper when the article is brought out.

Japanese Patent Laid-Open NO. 2001-266261 (paragraph 0021) discloses an article lending system that can detect an unauthorized bring-out of an article in a short time. In the system, when an article is lent out, a reading device reads the identifier from a noncontact tag attached to the article, and then the system sends the identifier to an article bring-out monitoring gate.

Japanese Patent Laid-Open NO. 2003-173478 (paragraph 0023) discloses an improper bring-out preventing system that distinguishes a well-intentioned customer who accidentally brings out something improperly and a malicious customer who intentionally brings out something improperly to prevent confusing the both. The system uses means for demagnetizing, at a checkout counter, a hard magnetic material adhered to a product used to indicate appropriateness of bring-out of the product to the outside of a shop.

Japanese Patent Laid-Open NO. 2003-296533 (paragraph 0049) discloses an asset management system that can manage asset correctly. In the system, asset carrying in/out permission information is registered and updated by an asset manager.

Japanese Patent Laid-Open NO. 2006-092431 (paragraph 0032) discloses a system for checking asset bring-out at a gate arranged at entrance/exit of a company, etc. using an RFID tag. The system checks whether or not asset bring-out has been registered using the identification number of the RFID tag. If it has been registered, the asset can pass through the gate. In the system, a metal detector performs a check if the bring-out has not been registered or if a noncontact tag has been taken off.

Japanese Patent Laid-Open NO. 2006-107308 (abstract) discloses a method of using biological information of a person to manage his/her exit or bring-out of an object at a pre-determined location or an exit of a facility by using a computer system. The system checks whether or not a combination of information of a person who brings out an object and information of a brought out article is correct. The information is registered by a manager.

In addition, Japanese Patent Laid-Open NO. 2006-018345 (paragraph 0005) and Japanese Patent Laid-Open NO. 2006-031675 (paragraph 0006) are related to the present invention.

### SUMMARY OF THE INVENTION

An exemplary object of the invention is to provide an asset bring-out management system, an asset bring-out management method, a brought out asset, and a brought out asset control program to reduce the problem of information leakage.

In an exemplary embodiment, an asset bring-out management system includes a brought out asset, a managing system that manages bring-out of the brought out asset to the outside of a management area, an encryption determining unit that determines whether or not encryption processing has been executed on the brought out asset, and a brought out information registering unit that registers brought out asset information in the managing system if the encryption processing has been executed on the brought out asset.

In an exemplary embodiment, an asset bring-out management method, includes determining whether or not encryption processing has been executed on a brought out asset of which bring-out to the outside of a management area is managed by a managing system, and registering information of the brought out asset in the managing system if the encryption processing has been executed on the brought out asset.

In an exemplary embodiment, a brought out asset, includes an encryption determining unit and a brought out information registering unit. The encryption determining unit determines whether or not encryption processing has been executed on the brought out asset of which bring-out to the outside of a management area is managed by a managing system. The brought out information registering unit registers brought out asset information in the managing system if the encryption processing has been executed on the brought out asset.

In an exemplary embodiment, a computer readable medium embodies a program. The program causes a brought out asset to perform a method. The method includes determining whether or not encryption processing has been executed on the brought out asset of which bring-out to the outside of a management area is managed by a managing system, and registering information of the brought out asset in a managing system if the encryption processing has been executed on the brought out asset.

### BRIEF DESCRIPTION OF THE DRAWINGS

Exemplary features and advantages of the present invention will become apparent from the following detailed description when taken with the accompanying drawings in which:

FIG. 1 is an exemplary drawing showing configurations of asset bring-out management system 1000 according to a first exemplary embodiment;

FIG. 2 is an exemplary drawing showing configurations of asset bring-out management system 1000 according to a first exemplary embodiment;

FIG. 3 is an exemplary drawing showing configuration of notebook PC 101 and noncontact IC card 105 according to the first exemplary embodiment;

FIG. 4 is an exemplary drawing showing configuration of notebook PC 101 and noncontact IC card 105 according to the first exemplary embodiment;

FIG. 5 is an exemplary drawing showing a configuration of management server 201 according to the first exemplary embodiment;

FIG. 6 is an exemplary drawing showing a configuration of monitoring device 301 according to the first exemplary embodiment;

FIG. 7 is an exemplary flowchart showing the operation of asset bring-out management system 1000 according to the first exemplary embodiment;

FIG. 8 is an exemplary flowchart showing the operation of monitoring system 300 according to the first exemplary embodiment;

FIG. 9 is an exemplary flowchart showing details of brought out information registration processing (step S105) according to the first exemplary embodiment;

FIG. 10 is an exemplary flowchart showing details of processing to use notebook PC 101 on the outside of a company (step S106) according to the first exemplary embodiment;

FIG. 11 is an exemplary flowchart showing details of bring-out termination processing (step S107) according to the first exemplary embodiment;

FIG. 12 is an exemplary flowchart showing details of the bring-out termination processing by a server (step S207) according to the first exemplary embodiment;

FIG. 13 is an exemplary drawing showing a configuration of asset bring-out management system 1000 according to a second exemplary embodiment; and

FIG. 14 is an exemplary flowchart showing the operation of management server 201 according to the second exemplary embodiment.

### DESCRIPTION OF THE EXEMPLARY EMBODIMENTS

Next, exemplary embodiments will be described in detail with reference to the drawings.

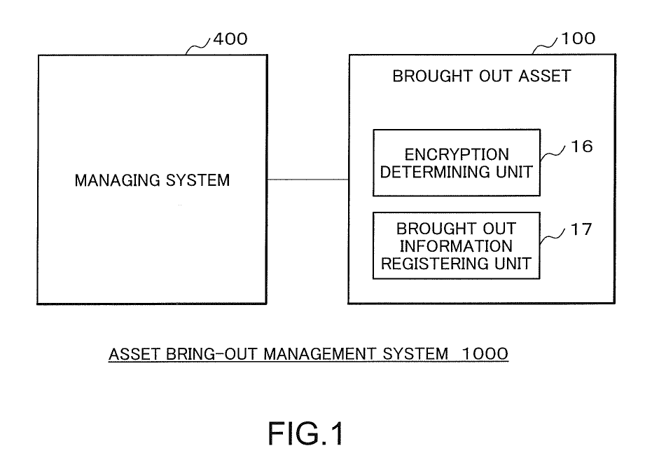

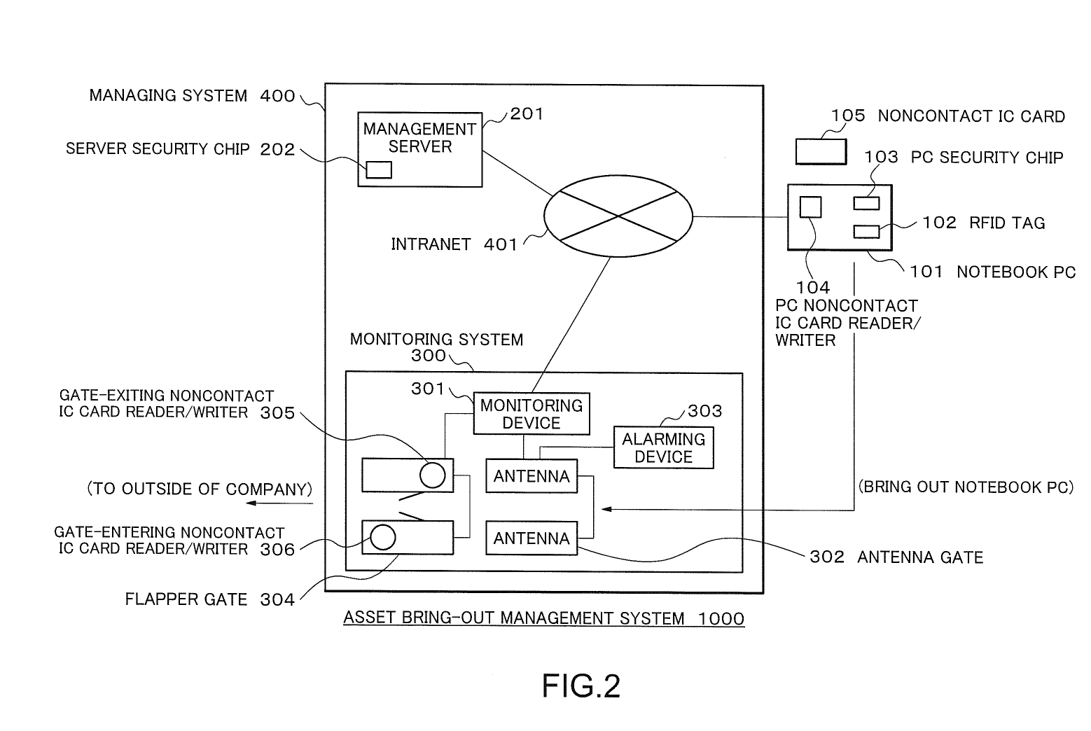

FIG. 1 is an exemplary drawing of asset bring-out management system 1000 and showing an overall configuration of a first exemplary embodiment. Asset bring-out management system 1000 shows an overall configuration of asset bring-out management system 1000 shown in FIG. 2. Asset bring-out management system 1000 includes brought out asset 100 and managing system 400 for managing bring-out of brought out asset 100 to the outside of a management area. Brought out asset 100 includes encryption determining unit 16 for determining whether or not encryption processing has been executed, and brought out information registering unit 17 for registering brought out asset information in the managing system if the encryption processing has been executed. In asset bring-out management system 1000 in FIG. 2 showing a detailed configuration of asset bring-out management system 1000, a notebook PC is illustrated as a brought out asset.

Asset bring-out management system 1000 operates as described below. Encryption determining unit 16 determines whether or not the encryption processing has been executed on brought out asset 100. Brought out information registering unit 17 registers the brought out asset information in managing system 400 if the encryption processing has been executed on brought out asset 100.

Asset bring-out management system 1000 has an effect of being able to provide an asset bring-out management system to reduce the problem of information leakage. It is because the asset bring-out management system including the brought out asset and the managing system for managing bring-out of the brought out asset to the outside of a management area (for example, the outside of a company) includes the encryption determining unit for determining whether or not the encryption processing has been executed on the brought out asset, and the brought out information registering unit for registering the brought out asset information in the managing system if the encryption processing has been executed on the brought out asset.

FIG. 2 is an exemplary drawing of asset bring-out management system 1000 showing a detailed configuration of the first exemplary embodiment. Asset bring-out management system 1000 includes, as shown in FIG. 2, notebook PC (one example of a brought out asset) 101 that is a target of the asset bring-out management, RFID (Radio Frequency Identification) tag (one example of a noncontact tag) 102 that records asset identification information attached to notebook PC 101, PC security chip (one example of a security chip of a brought out asset) 103, PC noncontact IC card reader/writer 104, noncontact IC card 105 (one example of a mobile information storing unit) and managing system 400. Managing system 400 includes management server 201 to register basic information and brought out information of an asset, monitoring system 300 and intranet 401 used for information communication among notebook PC 101, management server 201 and monitoring device 301.

Management server 201 includes server security chip 202. Monitoring system 300 includes monitoring device 301, antenna gate 302 to read asset identification information from RFID tag 102, alarming device 303, flapper gate 304, gate-exiting noncontact IC card reader/writer 305 and gate-entering noncontact IC card reader/writer 306.

A managing department allocates an asset management number for asset management to notebook PC 101 when a company newly purchases the PC, and also attaches RFID tag 102 to prevent improper bring-out of the PC along with a label of the asset management number to the PC. Notebook PC 101 includes PC security chip 103 and PC noncontact IC card reader/writer 104.

Person authentication (PC login) on notebook PC 101 is performed by noncontact IC card 105 via PC noncontact IC card reader/writer 104.

Noncontact IC card 105 is one example of a mobile information storing unit (for example, a managing department can use a mobile phone with a built-in noncontact IC as a mobile information storing unit). The managing department directs every company employee to carry noncontact IC card 105 storing his/her personal information to perform his/her entry/exit management using flapper gate 304 and monitoring device 301. Using these components, the managing department prepares for the case in that an improper person takes off RFID tag 102 (a noncontact tag) and brings out notebook PC 101 to the outside of the office.

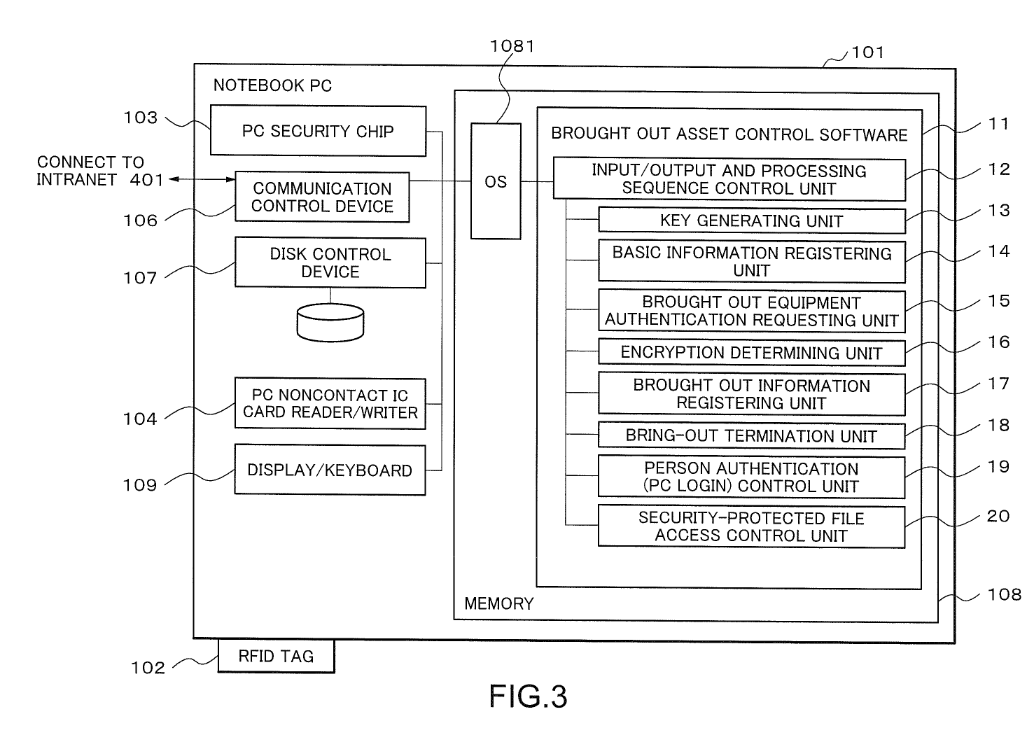

FIG. 3 is an exemplary drawing showing a configuration of notebook PC 101 according to the first exemplary embodiment.

Referring to FIG. 3, notebook PC 101 includes PC security chip 103, communication control device 106 for controlling communication with intranet 401, disk control device 107, PC noncontact IC card reader/writer 104, memory 108 and display/keyboard 109. RFID tag 102 to prevent improper bring-out is attached to notebook PC 101 along with an asset management number label.

Notebook PC 101 includes a micro processor (not shown) that operates according to program control. OS (Operating System) 1081 and brought out asset control software 11 are stored in a program storage medium (not shown). Notebook PC 101 reads out OS 1081 and brought out asset control software 11 described later to memory 108. The micro processor realizes respective functions of brought out asset control software 11 by executing OS 1081 and brought out asset control software 11.

Brought out asset control software 11 is a software program installed on notebook PC 101. Brought out asset control software 11 includes respective functions of input/output and processing sequence control unit 12, key generating unit 13, basic information registering unit 14, brought out equipment authentication requesting unit 15, encryption determining unit 16, brought out information registering unit 17, bring-out termination unit 18, person authentication (PC login) control unit 19 and security-protected file access control unit 20.

Brought out information control software 11 is required for a company to prevent leakage of information. Uninstallation of the software needs a noncontact IC card for management. The managing department manages the noncontact IC card, and temporarily lends out the card to a user when it acknowledges the need for uninstallation of the software by the user.

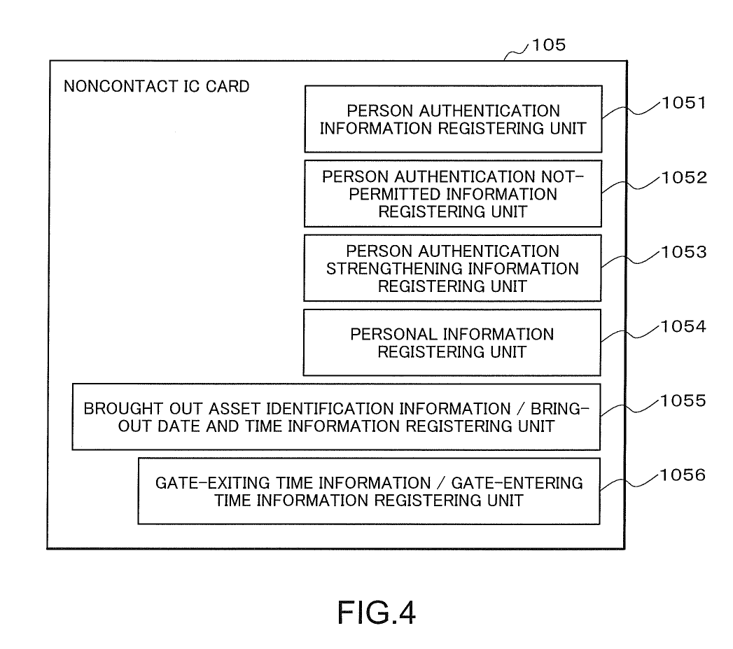

FIG. 4 is an exemplary drawing showing a configuration of noncontact IC card 105 according to the first exemplary embodiment.

Referring to FIG. 4, noncontact IC card 105 includes person authentication information registering unit 1051, person authentication not-permitted information registering unit 1052, person authentication strengthening information registering unit 1053, personal information registering unit 1054, brought out asset identification information/bring-out date and time information registering unit 1055, gate-exiting time information/gate-entering time information registering unit 1056. Contents of the respective information will be described in detail in relation to the operation.

Management server 201 is a server for managing asset bring-out of notebook PC 101 in a company. Management server 201 includes server security chip 202, communication control device 203 for controlling communication with intranet 401, disk control device 204, memory 206 and display/keyboard 205. A disk controlled by disk control device 204 stores brought out asset management DB 2041, personal information DB 2042 and security-protected files 2043.

Management server 201 includes a micro processor (not shown) that operates according to program control. The server reads out OS (Operating System) 2061 and brought out asset control software 21 described later to memory 206. OS 2061 and brought out asset control software 21 are stored in a program storage medium. The server realizes respective functions of brought out asset control software 21 through execution of brought out asset control software 21 and OS 2061 by the micro processor.

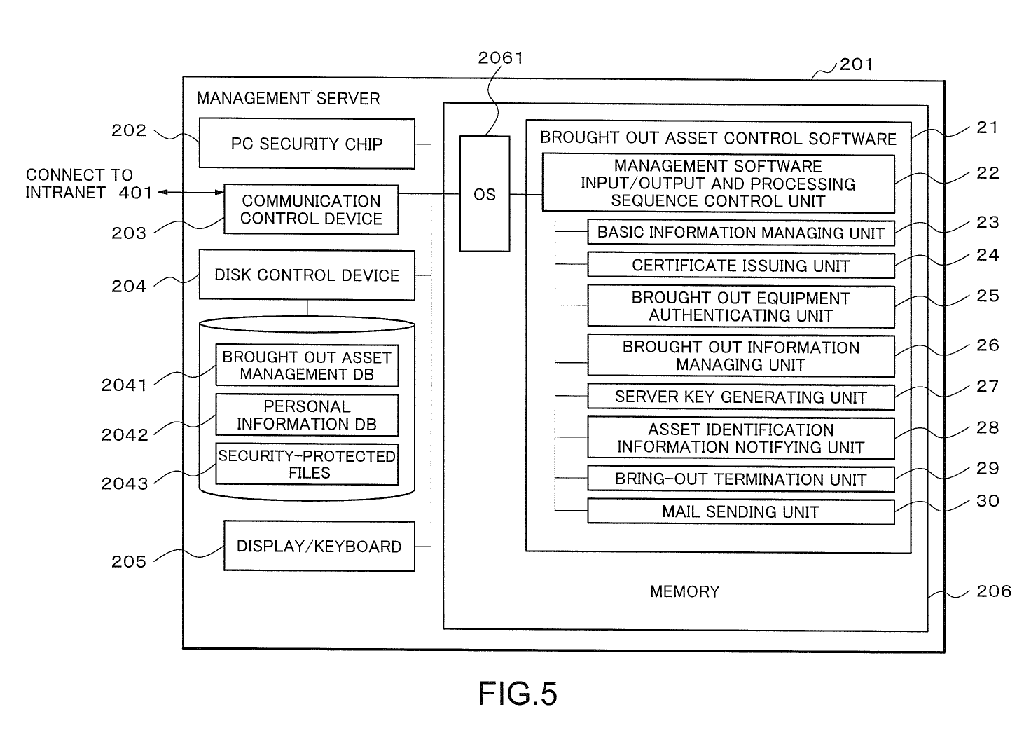

FIG. 5 is an exemplary drawing showing a configuration of management server 201 according to the first exemplary embodiment.

Referring to FIG. 5, a managing department installs brought out asset control software 21 as described before on management server 201. Brought out asset control software 21 includes respective functions of management software input/output and processing sequence control unit 22, basic information managing unit 23, certificate issuing unit 24, brought out equipment authenticating unit 25, brought out information managing unit 26, server key generating unit 27, asset identification information notifying unit 28, bring-out termination unit 29 and mail sending unit 30.

Management server 201 serves as a PKI (Public Key Infrastructure) private certification authority. Using a public key accepted from notebook PC 101, certificate issuing unit 24 issues a public key certificate for equipment authentication to confirm the genuineness of the equipment to notebook PC 101.

A manager detects a case in that basic information is not registered after a certain time period since notebook PC 101 was distributed to a using person using basic information managing unit 23 of management server 201. In that case, the manager confirms the reason and urges the registration.

Monitoring system 300 includes monitoring device 301, antenna gate 302, alarming device 303, flapper gate 304, gate-exiting noncontact IC card reader/writer 305 and gate-entering noncontact IC card reader/writer 306. Monitoring system 300 restricts bring-out of a brought out asset (for example, notebook PC 101) to the outside of a management area (outside a company).

Monitoring device 301 is a server-type information processing device for controlling antenna gate 302, alarming device 303 and flapper gate 304.

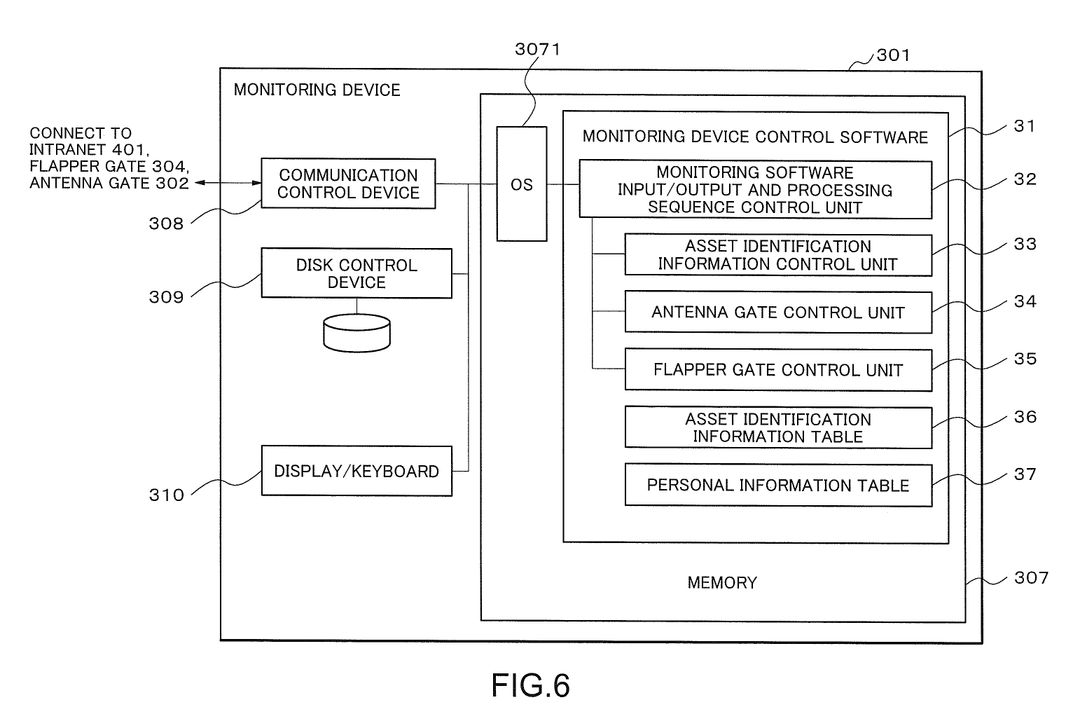

FIG. 6 is an exemplary drawing showing a configuration of monitoring device 301 according to the first exemplary embodiment.

Referring to FIG. 6, monitoring device 301 includes memory 307, disk control device 309, display/keyboard 310, and communication control device 308 for controlling communication with intranet 401, flapper gate 304 and antenna gate 302.

Monitoring device 301 includes a micro processor (not shown) that operates according to program control. The device reads out OS (Operating System) 3071 and monitoring device control software 31 stored in a program storage medium (not shown) to memory 307. The micro processor executes monitoring device control software 31 and OS 3071 to realize respective functions of monitoring device control software 31.

A managing department installs monitoring device control software 31 on monitoring device 301 as described before. Monitoring device control software 31 includes respective functions of monitoring software input/output and processing sequence control unit 32, asset identification information control unit 33, antenna gate control unit 34 and flapper gate control unit 35. The managing department arranges antenna gate 302, alarming device 303 and flapper gate 304 at an exit gate of the company. Flapper gate 304 includes gate-exiting noncontact IC card reader/writer 305 and gate-entering noncontact IC card reader/writer 306. Monitoring device control software 31 includes asset identification information table 36 and personal information table 37 on memory 307.

Antenna gate 302 is one example of an asset identification information reading unit for reading information from RFID tag 102.

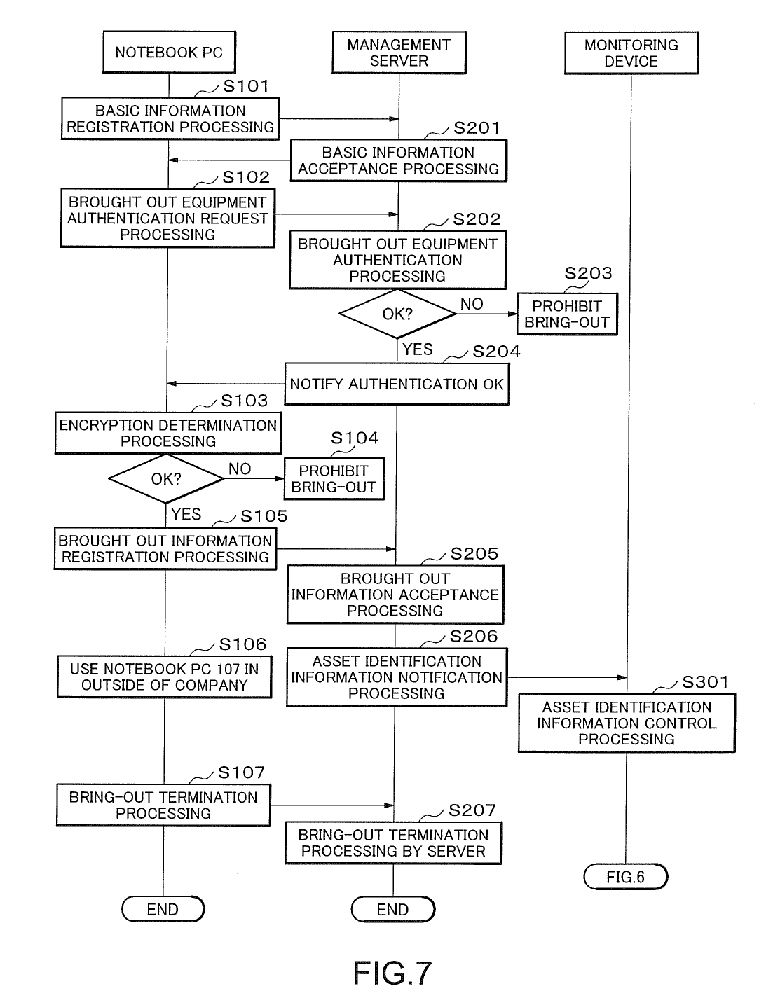

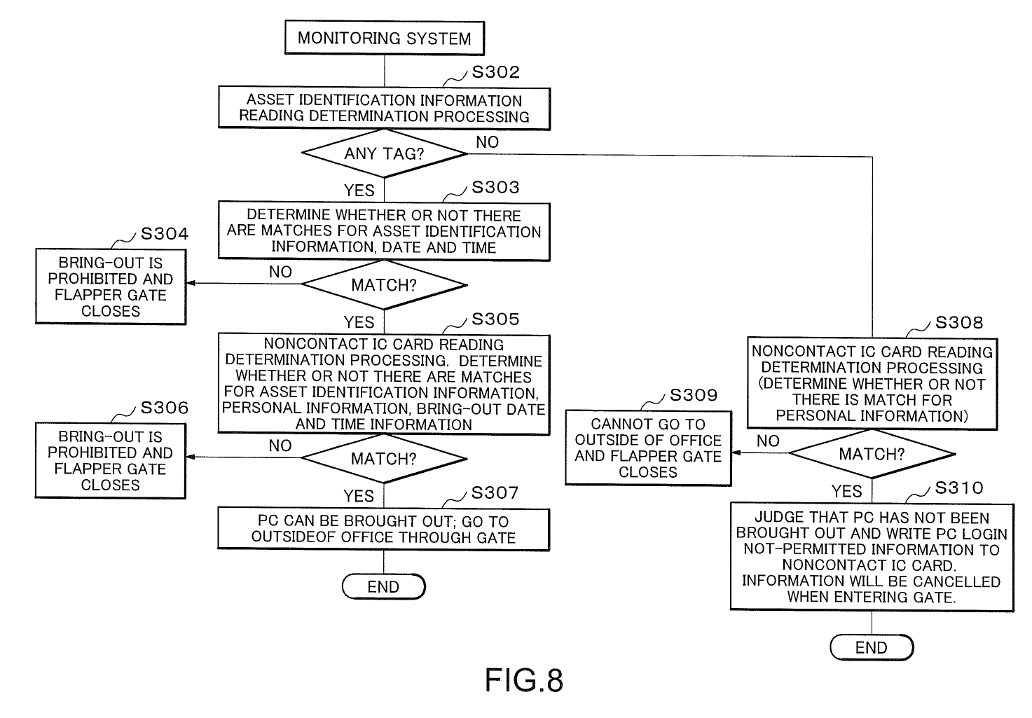

Next, the operation according to the first exemplary embodiment will be described in detail with reference to flowcharts in FIGS. 7 and 8.

FIG. 7 is an exemplary flowchart showing the operation of asset bring-out management system 1000 according to the first exemplary embodiment.

FIG. 8 is an exemplary flowchart showing the operation of monitoring system 300 according to the first exemplary embodiment.

First, a user performs basic information registration processing as advance preparation to bring out notebook PC 101 to the outside of a company (step S101). If the basic information has not been changed, the user needs to perform the processing only once at the beginning. Key generating unit 13 of brought out asset control software 11 generates a pair of keys (a public key and a secret key) of which secret key according to the public key cryptosystem cannot be transferred to other PCs in PC security chip 103 (that may be realized by Trusted Platform Module, for example).

A managing department sets encryption rule information indicating an encryption processing method according to the usage of notebook PC 101. A user selects a number from the encryption rule information being previously set by the managing department, for example, when an encryption tool A on a folder basis is used, the number is set to “1”, or when an encryption tool B for the entire hard disk is used, the number is set to “2”. The encryption rule information is defined according to the company policy.

Basic information registering unit 14 sends personal information, an asset management number given in the company, asset identification information, the generated public key, and company data encryption rule information to management server 201 via intranet 401.

Basic information registering unit 14 also registers person authentication (PC login) information, and asset identification information of RFID tag 102 in noncontact IC card 105 via PC noncontact IC card reader/writer 104. Afterward, the registration is performed by person authentication (PC login) control unit 19 using noncontact IC card 105.

Next, brought out asset control software 21 of management server 201 checks the validity of the basic information sent from notebook PC 101 by basic information managing unit 23, and registers the information in brought out asset management DB 2041.

Management server 201 issues a public key certificate for equipment authentication to notebook PC 101 by certificate issuing unit 24 using the accepted public key (step S201).

A user of notebook PC 101 that registered the basic information performs brought out equipment authentication request processing on management server 201 to bring out notebook PC 101 to the outside of the company (step S102).

When management server 201 receives an authentication request, brought out equipment authenticating unit 25 uses the public key certificate for the equipment authentication issued according to the SSL (secure socket layer) client authentication protocol when the basic information was registered, and the secret key protected by PC security chip 103 of notebook PC 101 to determine that notebook PC 101 is not spoofed (step S202). If the determination result is NO, brought out equipment authenticating unit 25 notifies notebook PC 101 of “bring-out prohibited” (step S203). If the determination result is YES, brought out equipment authenticating unit 25 notifies notebook PC 101 of “authentication OK” (step S204).

If the brought out equipment authentication is OK, brought out asset control software 11 performs encryption determination processing to determine before registration, by encryption determining unit 16, whether or not encryption processing has been executed in notebook PC 101 to be brought out (step S103).

If the encryption is, for example, on a folder basis (“1”) depending on the encryption rule information, every local folder has an encryption attribute. Accordingly, encryption determining unit 16 performs the encryption determination processing by confirming the encryption process is in operation.

It is judged that every local folder has an encryption attribute, as follows particularly. For example, in the case of the WINDOWS®, OS 1081 has the encryption attribute of the local folder in a data structure to manage properties of the local folder. According to the first exemplary embodiment, for example, OS 1081 confirms “effectiveness” of an encryption attribute in a data structure of OS 1081 to manage the properties of every local folder in notebook PC 101 according to the encryption rule information. Whether the data structure of OS 1081 is an array or a structure processed using a pointer depends on implemented OS 1081.

It is judged that the encryption process is in operation, as follows particularly. For example, in the case of the WINDOWS®, OS 1081 includes a list of processes being currently executed. According to the first exemplary embodiment, if the encryption attribute in the local folder is “effective”, the confirmation is accomplished by searching a data structure of the list of processes in execution managed by OS 1081 for a name of a process that performs encryption processing on files.

In the case of encryption of the entire hard disk (“2”), dedicated software has been installed on notebook PC 101. Accordingly, encryption determining unit 16 performs the encryption determination processing such as by confirming that the encryption process is in operation. Particularly, that the dedicated software has been installed depending on the encryption rule information can be confirmed by searching a data structure of a list of installed applications managed by OS 1081 for the software. If the installation of the dedicated software can be confirmed, encryption determining unit 16 can confirm that the encryption processing in the entire hard disk is executed by searching the data structure of the list of processes in execution managed by OS 1081 for the encryption process.

If the determination result is YES (S103/YES), brought out asset control software 11 proceeds to the next processing. If the result is NO (S103/NO), the software sets “bring-out prohibited” (step S104).

Security-protected file access control unit 20 calls and executes the encryption determination processing to access security-protected files 2043 in management server 201 in an office. Only if the result is YES (S103/YES), the security-protected files can be downloaded.

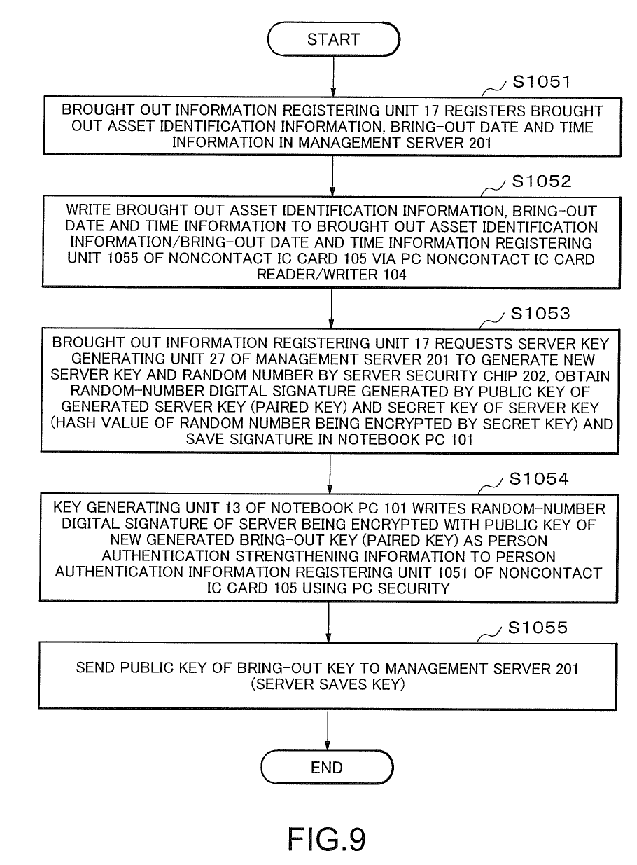

Next, notebook PC 101 performs brought out information registration processing (step S105). The brought out information registration processing will be described with reference to FIG. 9.

FIG. 9 is an exemplary flowchart showing details of the brought out information registration processing (step S105).

If a result of the encryption determination processing is YES (S103/YES), notebook PC 101 registers brought out asset identification information and bring-out date and time information at management server 201 using brought out information registering unit 17 (step S1051). The bring-out date and time information contains a bring-out time slot on a bring-out date, and date and time of a bring-out time limit. Then, notebook PC 101 writes the brought out asset identification information, and the bring-out date and time information to brought out asset identification information/bring-out date and time information registering unit 1055 in noncontact IC card 105 via PC noncontact IC card reader/writer 104 (step S1052).

Brought out information registering unit 17 further requests server key generating unit 27 of management server 201 to newly generate a server key and a random number using server security chip 202. Brought out information registering unit 17 obtains a public key of the generated server key (paired key) and a random-number digital signature (the hash value of the random number encrypted with the secret key) generated using a secret key of the server key, and saves the signature in notebook PC 101 (step S1053).

Then, key generating unit 13 of notebook PC 101 newly generates a bring-out key (paired key) using PC security chip 103, and encrypts a random-number digital signature of the server with a public key of the generated bring-out key. Key generating unit 13 writes the encrypted random-number digital signature of the server as person authentication strengthening information to person authentication information registering unit 1051 of noncontact IC card 105 (step S1054). Key generating unit 13 also sends the public key of the generated bring-out key to management server 201 (step S1055). Management server 201 saves the public key of the bring-out key (step S1055).

According to the first exemplary embodiment, a bring-out key and a server key are newly generated for each bring-out, thereby reducing the risk of spoof and tampering.

Notebook PC 101 performs processing for one-to-one correspondence between notebook PC 101 and noncontact IC card 105 as above to check that an employee can bring out only a single PC for security when the employee logs in the PC. Brought out information registering unit 17 checks such that an employee can register to only one PC for bring-out.

After the registration of the brought out information, security-protected file access control unit 20 in notebook PC 101 checks the bring-out information and prohibits new download from security-protected files 2043.

To resume the download needs processing by bring-out termination unit 18. When brought out information managing unit 26 of management server 201 accepts the brought out information registration, it registers the brought out asset identification information, the bring-out date and time information, and the personal information in brought out asset management DB 2041 and personal information DB 2042 (step S205).

Asset identification information notifying unit 28 notifies monitoring device 301 of brought out asset identification information, bring-out date and time information, and personal information corresponding to asset identification information in RFID tag 102 attached to brought out notebook PC 101 via intranet 401 (step S206).

Monitoring device 301 adds the brought out asset identification information, the bring-out date and time information, and the personal information notified by asset identification information control unit 33 to asset identification information table 36 and personal information table 37 on memory 307 (step S301).

When a user of notebook PC 101 enters antenna gate 302 with bearing notebook PC 101, antenna gate control unit 34 of monitoring device 301 determines whether or not it can read asset identification information in RFID tag 102 (step S302). Monitoring device 301 scans asset identification information table 36 on memory 307, and determines whether or not there is a match for the asset identification information (step S303), and whether or not the read date and time is within a bring out time slot in the bring-out date and time information. If the determination result is NO (S303/NO), monitoring device 301 actuates alarming device 303 to close flapper gate 304 (step S304).

If the determination result is YES (S303/YES), the user of notebook PC 101 holds noncontact IC card 105 over gate-exiting noncontact IC card reader/writer 305 of flapper gate 304.

Gate-exiting noncontact IC card reader/writer 305 reads personal information registered in personal information registering unit 1054 of noncontact IC card 105 held over by the user of notebook PC 101, brought out asset identification information and bring-out date and time information registered in brought out asset identification information/bring-out date and time information registering unit 1055.

Monitoring device 301 scans asset identification information table 36 and personal information table 37 on memory 307 and determines whether or not there are each matches for the personal information, the brought out asset identification information, and the bring-out date and time information (step S305). If the determination result is NO (S305/NO), monitoring device 301 closes flapper gate 304 (step S306).

If the determination result is YES (S305/YES), it can be confirmed that noncontact IC card 105 belongs to the user who registered the bring-out, hence notebook PC 101 can be brought out. The user of notebook PC 101 can go outside of the office through flapper gate 304 (step S307).

If the asset identification information in RFID tag 102 cannot be read (S302/NO), gate-exiting noncontact IC card reader/writer 305 reads out personal information registered in personal information registering unit 1054 of noncontact IC card 105 in entry/exit management. Monitoring device 301 determines whether or not the personal information read out by gate-exiting noncontact IC card reader/writer 305 matches personal information table 37 (step S308). If it does not match, monitoring device 301 closes flapper gate 304 (step S309).

If the information matches (S308/YES), monitoring device 301 writes person authentication (PC login) not-permitted information to person authentication not-permitted information registering unit 1052 of noncontact IC card 105 since the user does not bring out notebook PC 101 (step S310).

If the person authentication (PC login) not-permitted information has been written in noncontact IC card 105, the user cannot log in notebook PC 101, hence the user cannot use notebook PC 101.

In the above manner, even if a user removes RFID tag 102 from notebook PC 101 to improperly bring out notebook PC 101, the user cannot use notebook PC 101 since the user cannot log in notebook PC 101 in the outside of the company.

When a user passes through a gate to enter a company, monitoring device 301 cancels person authentication (PC login) not-permitted information using gate-entering noncontact IC card reader/writer 306.

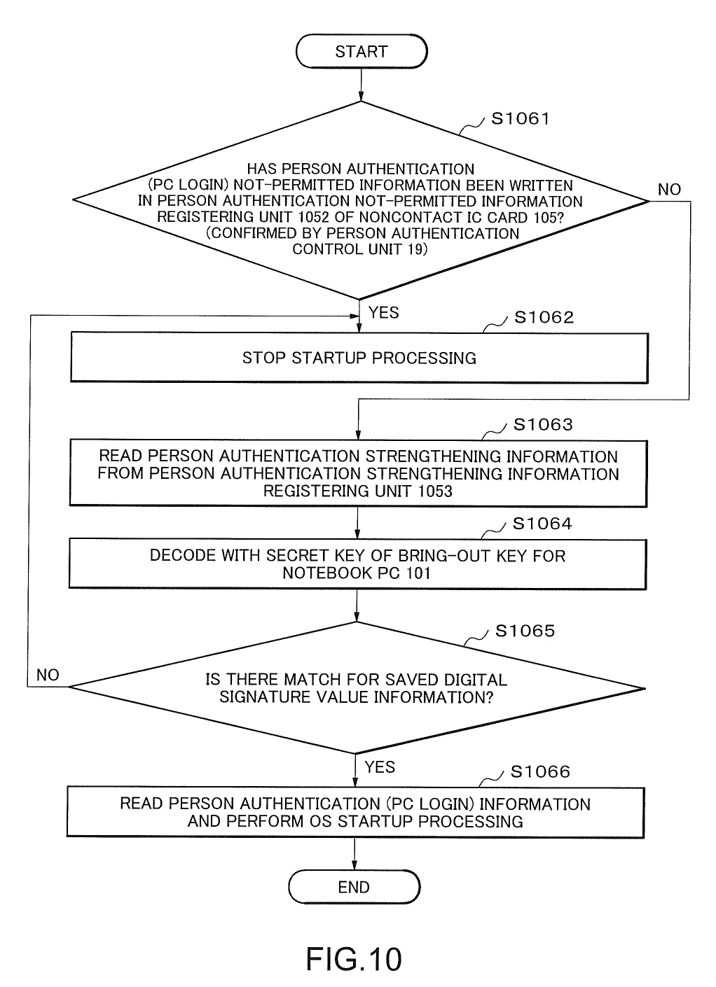

The use of notebook PC 101 in the outside of a company (step S106) will be described with reference to FIG. 10. FIG. 10 is an exemplary flowchart showing details of processing to use notebook PC 101 in the outside of a company (step S106).

When a user starts up notebook PC 101 in the outside of the company, person authentication (PC login) control unit 19 reads noncontact IC card 105 to determine whether or not person authentication (PC login) not-permitted information has been written in person authentication not-permitted information registering unit 1052 of noncontact IC card 105 (step S1061). If the information has been written in card 105 (S1061/YES), unit 19 stops the startup processing (S1062). That is, notebook PC 101 stops the startup processing without reading the person authentication information for login to notebook PC 101 registered in person authentication information registering unit 1051.

If the person authentication (PC login) not-permitted information has not been written in (S1061/No), person authentication (PC login) control unit 19 reads person authentication strengthening information from person authentication strengthening information registering unit 1053 (step S1063). Person authentication (PC login) control unit 19 decodes the information with a secret key of a bring-out key for notebook PC 101 (step S1064), and determines whether or not the information matches saved digital signature value information (step S1065). In this manner, person authentication (PC login) control unit 19 confirms that the card corresponds to the PC one-to-one, reads the person authentication (PC login) information from person authentication information registering unit 1051 and performs the OS startup processing (step S1066). Anyone other than a user who registered for the bring-out of notebook PC 101 cannot use the PC.

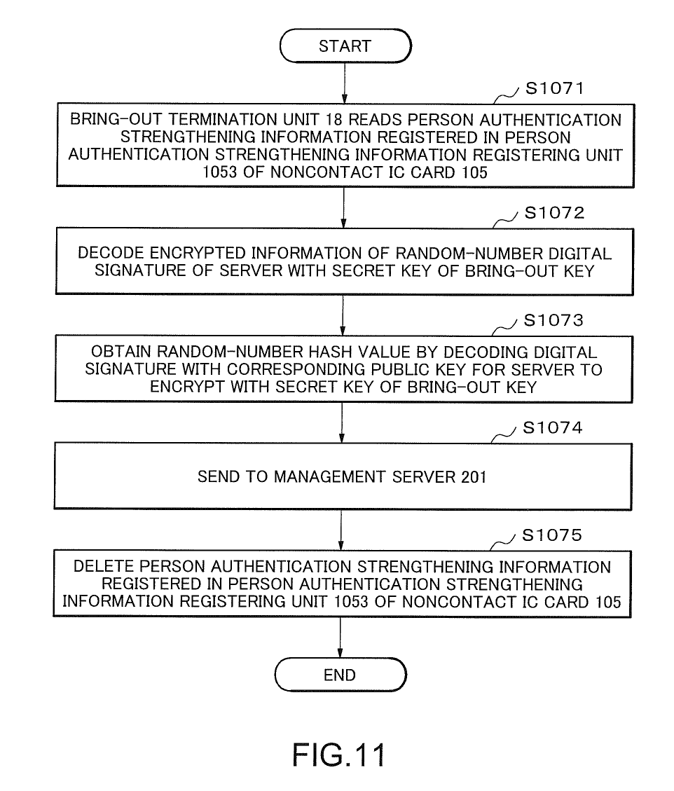

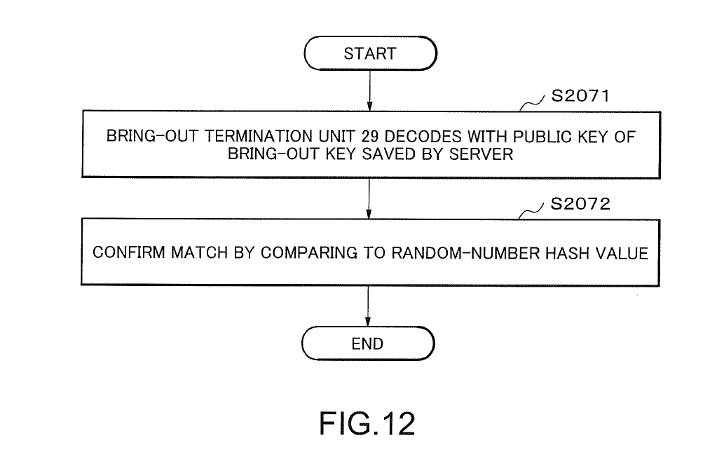

After the user of notebook PC 101 has brought back the PC, the user performs bring-out termination processing (step S107) by bring-out termination unit 18. The bring-out termination processing will be described with reference to FIGS. 11 and 12. FIG. 11 is an exemplary flowchart showing details of the bring-out termination processing (step S107). FIG. 12 is an exemplary flowchart showing details of bring-out termination processing by a server (step S207).

Bring-out termination unit 18 reads the person authentication strengthening information registered in person authentication strengthening information registering unit 1053 of noncontact IC card 105 (step S1071), and decodes encrypted information of a random-number digital signature of the server with the secret key of the bring-out key (step S1072). Bring-out termination unit 18 further decodes the digital signature with the corresponding public key for the server to obtain the hash value of the random number, encrypts the hash value with the secret key of the bring-out key (step S1073) and sends the result to management server 201 (step S1074). In management server 201, bring-out termination unit 29 performs the bring-out termination processing by the server (step S207), decodes the encrypted hash value with the public key of the bring-out key saved by the server (step S2071), compares the result to the hash value of the random number and confirms that the result matches the hash value (step S2072).

In the above manner, notebook PC 101 confirms that the authentication information in noncontact IC card 105 has not been tampered, and then, can resume download of security-protected files. Monitoring device 301 deletes the person authentication strengthening information registered in person authentication strengthening information registering unit 1053 of noncontact IC card 105 when the user enters the company through a gate (step S1075). In this way, the user can log in plurality of notebook PCs 101 by using noncontact IC card 105 in the company.

Asset identification information control unit 33 of monitoring device 301 feeds back information and time being read and written by gate-entering noncontact IC card reader/writer 306, gate-exiting noncontact IC card reader/writer 305 and antenna gate 302 to manage brought out information to management server 201. Brought out information managing unit 26 records the fed back information in brought out asset management DB 2041. Monitoring device 301 similarly feeds back information for entry/exit management. Brought out information managing unit 26 of management server 201 records the fed back information for entry/exit management in personal information DB 2042.

Monitoring device 301 also writes the gate-exiting time information and the gate-entering time information to gate-exiting time information/gate-entering time information registering unit 1056 of noncontact IC card 105. Bring-out termination unit 18 notifies brought out information managing unit 26 of management server 201 of the information, while brought out information managing unit 26 records the gate-exiting time information and the gate-entering time information in brought out asset management DB 2041.

Brought out information managing unit 26 occasionally checks that the information is consistent. In case of accident or trouble, the information is utilized as tracing information.

In the above manner, the operation of the first exemplary embodiment is completed.

The first exemplary embodiment has an effect of providing the asset bring-out management system to reduce the problem of information leakage. It is because the asset bring-out management system including brought out asset (for example, a notebook PC), and the managing system to manage bring-out to the outside of an area to manage the brought out asset (for example, the outside of the company) includes the encryption determining unit for determining whether or not the encryption processing has been executed on the brought out asset, and the brought out information registering unit for registering the brought out asset information at the managing system if the encryption processing has been executed on the brought out asset.

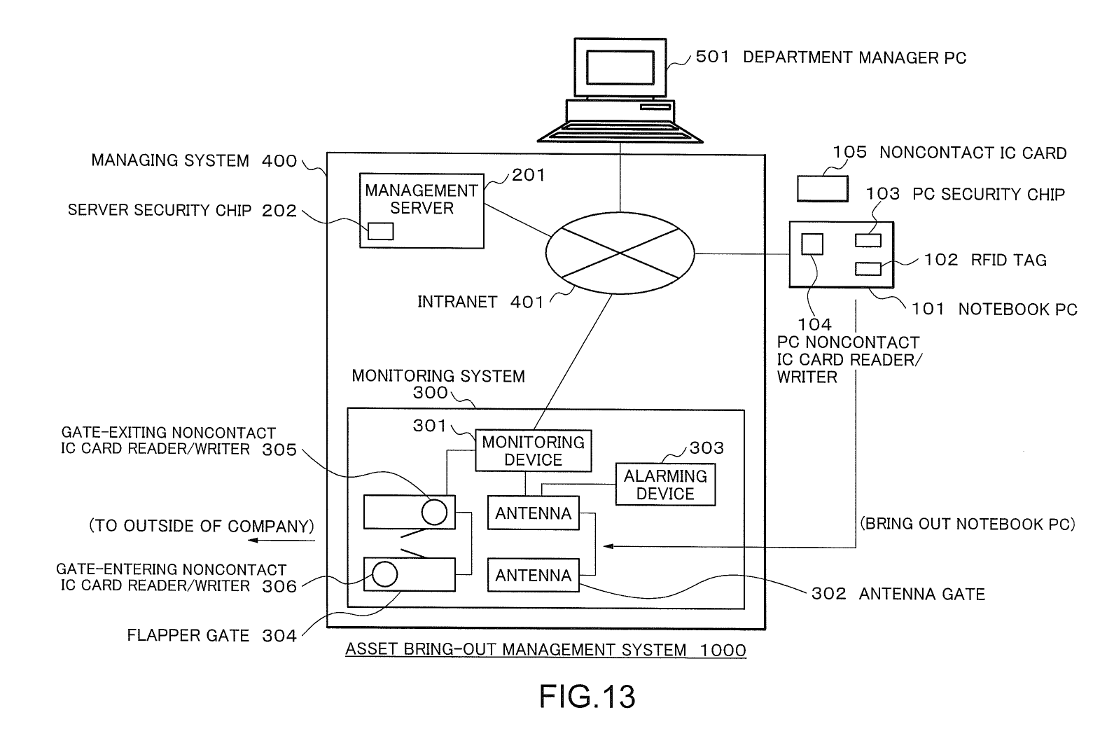

Next, a second exemplary embodiment will be described in detail with reference to the drawings. FIG. 13 is an exemplary drawing showing a configuration of asset bring-out management system 1000 according to the second exemplary embodiment. In the configuration of the second exemplary embodiment, department manager PC 501 is added to the configuration in FIG. 2 according to the first exemplary embodiment, as shown in FIG. 13.

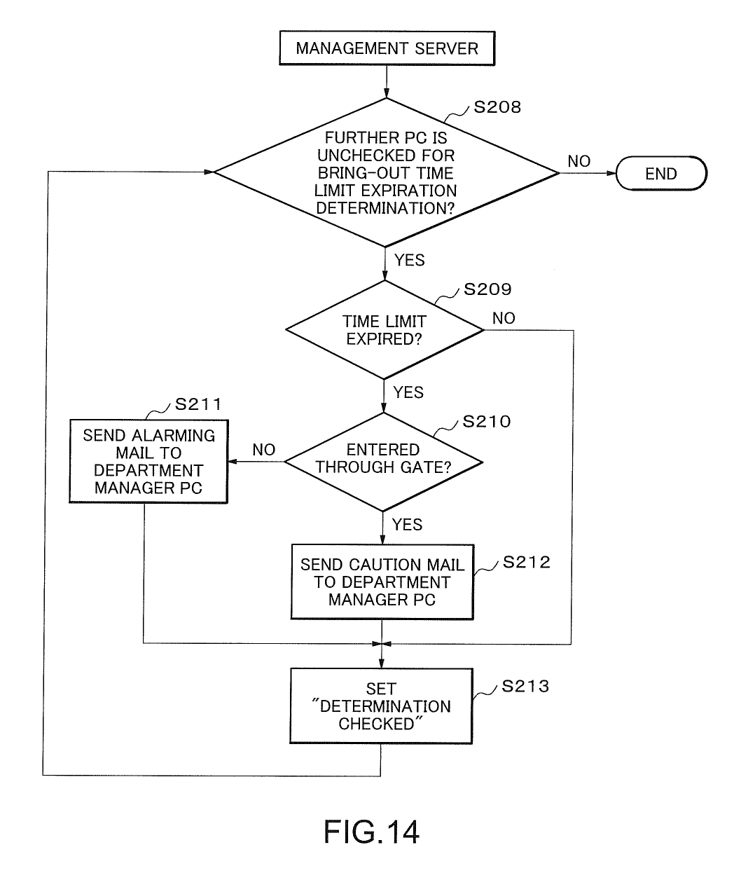

Next, the operation of the second exemplary embodiment will be described in detail with reference to FIG. 14. FIG. 14 is an exemplary flowchart showing the operation of management server 201 according to the second exemplary embodiment.

First, the second exemplary embodiment entirely performs operation similar to the operation of the first exemplary embodiment. Afterward, brought out information managing unit 26 of management server 201 checks whether there is notebook PC 101 which has not performed the bring-out termination processing and has caused a bring-out time limit to expire once a day (step S208). If there is not a PC for which bring-out time limit expiration is unchecked (S208/NO), brought out information managing unit 26 ends the processing.

If there is any PC for which bring-out time limit expiration is unchecked (S208/YES), brought out information managing unit 26 judges whether or not the time limit expires (step S209). That is, brought out information managing unit 26 checks bring-out date and time information corresponding to the PC for which bring-out time limit expiration is unchecked in brought out asset management DB 2041. If the time limit does not expire (S209/NO), brought out information managing unit 26 judges that the determination has been checked (step S213).

If the time limit expires (S209/YES), brought out information managing unit 26 judges whether or not relevant notebook PC 101 has passed through a gate to enter the company (step S210). That is, brought out information managing unit 26 checks the gate-entering time information of the PC for which bring-out time limit expiration is unchecked in brought out asset management DB 2041.

Depending on the judgment result, mail sending unit 30 sends, for example, a caution or alarming e-mail to department manager PC 501 of the head of the department to which the user of notebook PC 101 belongs (steps S210 and S211). If it is assumed that notebook PC 101 and the user have been already inside the company by passing through the gate and the bring-out termination processing delays (S210/YES), mail sending unit 30 sends a caution mail (step S212). If the user has exited through the gate and brought out the PC (S210/NO), unit 30 sends an alarming mail (step S211).

In the above manner, the operation of the second exemplary embodiment is completed.

As described in the above, according to the second exemplary embodiment, appropriate bring-out management can be accomplished to give caution and alarm, by an e-mail, to the manager of a department to which a user of a bring-out time limit been expired notebook PC belongs. The management can quickly address troubles. It is because the monitoring system includes the asset identification information control unit to notify the management server of bring-out and bring-in of the brought out asset to the outside/into a management area, as described in the above.

The bring-out monitoring system disclosed in a reference has a problem in that it induces the leakage of information when used to monitor company assets.

It is because in the bring-out monitoring system disclosed in the reference, a brought out asset that may retain confidential information can be brought out without being encrypted (the brought out asset can be registered at the monitoring system as being permitted to be brought out) when the asset is brought out. That is, the bring out monitoring system disclosed in the reference does not check details of the brought out asset when information such as an identifier of the brought out asset permitted to be brought out is registered at the monitoring system (whether or not being encrypted).

On the contrary, the exemplary embodiments have exemplary advantages as follows, for example.

The exemplary embodiments have an effect of providing the asset bring-out management system to reduce the problem of information leakage. It is because according to the exemplary embodiments, the asset bring-out management system including a brought out asset (for example, a notebook PC), and the managing system for managing bring-out of the brought out asset to the outside of the management area (for example, to the outside of the company) includes the encryption determining unit for determining whether or not the encryption processing has been executed on the brought out asset, and the brought out information registering unit for registering brought out asset information at the managing system if the encryption processing has been executed on the brought out asset.

That is, the exemplary embodiments check whether or not the company data has been encrypted before the notebook PC is brought out to the outside of the company. If the data has not been encrypted, then the notebook PC cannot be brought out to the outside of the company, preventing the leakage of the company data information if the notebook PC is stolen. Previous bring-out registration of a notebook PC does not clarify whether or not the company data has been encrypted, but the exemplary embodiments solve the problem.

Further, the exemplary embodiments have an effect of deterring an improper act to remove an RFID tag attached to a notebook PC, for example. It is because according to the exemplary embodiments, if a notebook PC is not detected when a user goes out of a management zone, and the personal information read out from the noncontact IC card matches personal information registered in the managing system, then the person authentication not-permitted information is registered in the noncontact IC card. That is, according to the exemplary embodiments, if the RFID tag attached to the notebook PC is taken off, the person authentication for the notebook PC cannot be performed in the outside of the company and the PC cannot be used. Therefore, the embodiments can deter such an improper act.

Furthermore, for a similar reason, the exemplary embodiments have an effect of achieving the above effect at a low cost, for example. The related arts have problems in that not only a noncontact tag is removed, but also information in a RFID tag is made unreadable by radio wave absorbents. To solve the problems, a metal detector and an X-ray screening machine may be further added, which induces difficult operation and a high cost. The exemplary embodiments have an effect of deterring an improper act of removing an RFID tag attached to a notebook PC without inducing a high cost, and an improper act of making information in an RFID tag unreadable by radio wave absorbents. The exemplary embodiments can be used with a metal detector and the like.

The exemplary embodiments also have an effect of realizing secure bring-out of one notebook PC by one user, for example. It is because the exemplary embodiments use keys of security chips for the management server and the notebook PC.

The exemplary embodiments also have an effect of more accurately grasping circumstances in which a brought out asset such as a notebook PC are brought out, for example. That is, the exemplary embodiments can automatically check whether or not a user who brings out an asset had finished the bring-out and entered a gate. It is because the monitoring system includes the asset identification information control unit for notifying the management server of the bring-out and bring-in of the brought out asset to the outside of/into a management area.

The exemplary embodiments can also switch between a “caution mail” (when a user has entered through the gate) and an “alarming mail” (when a user has not entered through the gate) corresponding to a reminder mail at the time limit expiration, for example. It is because the monitoring system includes the asset identification information control unit for notifying the management server of the bring-out and bring-in of the brought out asset to the outside of/into a management area, as described in the above.

The exemplary embodiments are applicable to an asset bring-out management system, an asset bring-out management method, a brought out asset, and a brought out asset control program to prevent the leakage of information.

The exemplary embodiments have an effect of providing the asset bring-out management system to reduce the problem of information leakage. It is because according to the exemplary embodiments, the asset bring-out management system including a brought out asset, and the managing system for managing bring-out of the brought out asset to the outside of a management area includes the encryption determining unit for determining the encryption processing has been executed on the brought out asset, and the brought out information registering unit for registering brought out asset information at the managing system if the encryption processing has been executed on the brought out asset.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. An asset bring-out management system comprising:
a brought out asset;
a managing system that manages bring-out of the brought out asset to the outside of a management area;
an encryption determining unit that determines whether or not encryption processing has been executed on the brought out asset; and
a brought out information registering unit that registers brought out asset information in the managing system if the encryption processing has been executed on the brought out asset.

2. The asset bring-out management system according to claim 1,
wherein the managing system includes:
a monitoring system that reads out the brought out asset information from the brought out asset when the brought out asset is brought out to the outside of the management area, and restricts bring-out of the brought out asset to the outside of the management area if the read out information does not match the brought out asset information registered in the managing system.

3. The asset bring-out management system according to claim 2, comprising:
a mobile information storing unit in which personal information of a person who brings out the asset is registered by the brought out asset,
wherein the managing system includes a personal information database in which the personal information of the person who brings out the asset is registered from the brought out asset;
wherein the monitoring system:
reads out the personal information from the mobile information storing unit when the brought out asset is brought out to the outside of the management area if the brought out asset information read out from the brought out asset matches the brought out asset information registered in the managing system; and
restricts bring-out of the brought out asset information to the outside of the management area if the personal information read out from the mobile information storing unit does not match the personal information registered in the personal information database.

4. The asset bring-out management system according to claim 3,
wherein the mobile information storing unit includes:
a person authentication information registering unit that registers person authentication information to log in the brought out asset; and
a person authentication not-permitted information registering unit that registers person authentication not-permitted information for not reading the person authentication information if the brought out asset is detected during login processing;
wherein the monitoring system:
registers the person authentication not-permitted information in the person authentication not-permitted information registering unit if the brought out asset cannot be detected, and the personal information read out from the mobile information storing unit matches the personal information registered in the managing system.

5. The asset bring-out management system according to claim 4,
wherein the monitoring system:
deletes the person authentication not-permitted information if the person authentication not-permitted information has been registered in the mobile information storing unit when bringing the mobile information storing unit into the management area.

6. The asset bring-out management system according to claim 3,
wherein the managing system includes a management server that manages the asset bring-out management system, the management server generates a digital signature, and the brought out asset encrypts the digital signature with a key generated by the brought out asset to generate person authentication strengthening information;
wherein the mobile information storing unit includes:
a person authentication strengthening information registering unit that registers the person authentication strengthening information,
wherein the brought out asset:
includes a person authentication control unit that reads the person authentication strengthening information from the mobile information storing unit, decodes the person authentication strengthening information with the key generated by the brought out asset, and determines whether the decoding result matches digital signature information saved by the brought out asset itself, and
performs startup processing if the determination result indicates a match.

7. The asset bring-out management system according to claim 6,
wherein the brought out asset includes:
a bring-out termination unit that reads the person authentication strengthening information from the mobile information storing unit, decodes the person authentication strengthening information with the key generated by the brought out asset, decodes the digital signature gained as a result of the decoding with a key generated by the management server, encrypts a hash value gained as a result of the decoding with the key generated by the brought out asset, and sends the encrypted hash value to the management server,
wherein the management server includes:
a bring-out termination unit in the management server that decodes the encrypted hash value, and performs bring-out termination processing to determine whether or not the encrypted hash value matches a hash value saved by the management server itself.

8. The asset bring-out management system according to claim 6,
wherein the management server includes:
a server security chip that generates a server key and a random number, and generates a random-number digital signature using a public key of the server key and a secret key of the server key,
wherein the brought out asset includes:
a brought out information registering unit that obtains and saves the public key of the server key and the digital signature; and
a security chip of the brought out asset that generates a public key of a bring-out key (paired key), and generates the person authentication strengthening information by encrypting the digital signature with the public key,
wherein the person authentication strengthening information registering unit of the mobile information storing unit registers the person authentication strengthening information.

9. The asset bring-out management system according to claim 8,
wherein the brought out asset:
includes a person authentication control unit that reads the person authentication strengthening information from the mobile information storing unit at startup, decodes the information with the secret key of the bring-out key, and determines whether or not the decoding result matches the digital signature saved by the brought out asset itself; and
performs startup processing if the determination result indicates a match.

10. The asset bring-out management system according to claim 9,
wherein the brought out asset includes:
a bring-out termination unit that reads the person authentication strengthening information from the mobile information storing unit, decodes the person authentication strengthening information with the public key of the bring-out key, decodes the digital signature gained as a result of the decoding with the public key of the server key, encrypts a random-number hash value gained as a result of the decoding with the secret key of the bring-out key, and sends the encrypted random-number hash value to the management server,
wherein the management server includes:
a bring-out termination unit in the management server that decodes the encrypted random-number hash value with the public key of the bring-out key, and performs the bring-out termination processing to determine whether or not the decoding result matches the random-number hash value saved by the management server itself.

11. The asset bring-out management system according to claim 7,
wherein the monitoring system includes:
an asset identification information control unit that notifies the management server of bring-out/bring-in the brought out asset to the outside of/into the management area,
wherein the management server includes:
a brought out asset management database that records whether or not the bring-out/the bring-in of the brought out asset to the outside of/into the management area and the bring-out termination processing are completed,
wherein the management server includes a mail sending unit that:
sends a caution mail if a bring-out termination processing time limit is exceeded, and there is any brought out asset brought in from the outside of the management area; and
sends an alarming mail if the bring-out termination processing time limit is exceeded, and there is any brought out asset not brought in from the outside of the management area.

12. An asset bring-out management method, comprising:
determining whether or not encryption processing has been executed on a brought out asset of which bring-out to the outside of a management area is managed by a managing system; and
registering information of the brought out asset in the managing system if the encryption processing has been executed on the brought out asset.

13. The asset bring-out management method according to claim 12, comprising:
reading out the brought out asset information from the brought out asset when the brought out asset is brought out to the outside of the management area, and restricting bring-out of the brought out asset to the outside of the management area if the read out information does not match the brought out asset information registered in the managing system.

14. The asset bring-out management method according to claim 13, comprising:
reading out personal information from a mobile information storing unit in which personal information of a person who brings out the asset has been registered using the brought out asset if the brought out asset information read out from the brought out asset matches the brought out asset information registered in the managing system when the brought out asset is brought out to the outside of the management area; and
restricting bring-out of the brought out asset information to the outside of the management area if the personal information read out from the mobile information storing unit does not match personal information registered in a personal information database that is included in the manager's system and in which the personal information of the person who brings out the asset has been registered from the brought out asset.

15. The asset bring-out management method according to claim 14, comprising:
registering person authentication information to log in the brought out asset in the mobile information storing unit; and
registering person authentication not-permitted information not to read the person authentication information if the brought out asset is detected during login processing in a person authentication not-permitted information registering unit of the mobile information storing unit if the brought out asset cannot be detected, and the personal information read out from the mobile information storing unit matches the personal information registered in the managing system.

16. The asset bring-out management method according to claim 15, comprising:
deleting the person authentication not-permitted information if the person authentication not-permitted information has been written in the mobile information storing unit when the mobile information storing unit is brought into the management area.

17. The asset bring-out management method according to claim 13, comprising:
by a management server that manages the asset bring-out management system, generating a digital signature;
by the brought out asset, generating person authentication strengthening information by encrypting the digital signature with a key generated by the brought out asset;
by the mobile information storing unit, registering the person authentication strengthening information;
by the brought out asset, reading the person authentication strengthening information from the mobile information storing unit, decoding the person authentication strengthening information, and determining whether or not the decoding result matches saved digital signature value information; and
by the brought out asset, performing startup processing if the determination result indicates a match.

18. The asset bring-out management method according to claim 17, comprising:
by the brought out asset, reading the person authentication strengthening information from the mobile information storing unit, decoding the person authentication strengthening information with a key generated by the brought out asset, decoding the digital signature gained as a result of the decoding with a key generated by the management server, encrypting a hash value gained as a result of the decoding with the key generated by the brought out asset, and sending the encrypted hash value to the management server; and
by the management server, decoding the encrypted hash value, and performing bring-out termination processing to determine whether or not the encrypting result matches a hash value saved in the management server itself.

19. The asset bring-out management method according to claim 17, comprising:
by the management server, generating a server key and a random number, and generating a random-number digital signature using a public key of the server key and a secret key of the server key;
by the brought out asset, obtaining and saving the public key of the server key and the digital signature, generating a public key of a bring-out key (paired key), and generating the person authentication strengthening information by encrypting the digital signature with the public key; and
by the person authentication strengthening information registering unit of the mobile information storing unit, registering the person authentication strengthening information.

20. The asset bring-out management method according to claim 19, comprising:
by the brought out asset:
reading person authentication strengthening information from the mobile information storing unit at startup, decoding the information with the secret key of the bring-out key, and determining whether or not the decoding result matches the digital signature saved in the brought out asset itself; and
performing startup processing if the determination result indicates a match.

21. The asset bring-out management method according to claim 20, comprising:
by the brought out asset, reading the person authentication strengthening information from the mobile information storing unit, decoding the person authentication strengthening information with the public key of the bring-out key, decoding the digital signature gained as a result of the decoding with the public key of the server key, encrypting a random-number hash value gained as a result of the decoding with a secret key of the bring-out key, and sending the encrypted random-number hash value to the management server; and
by the management server, decoding the encrypted random-number hash value with the public key of the bring-out key, and performing bring-out termination processing to determine whether or not the decoding result matches a random-number hash value saved in the management server itself.

22. The asset bring-out management method according to claim 18, comprising:
by the monitoring system, notifying the management server of bring-out/bring-in of the brought out asset to the outside of/into the management area;
by the management server, recording whether or not the bring-out/the bring-in of the brought out asset to the outside of/into the management area and bring-out termination processing have been completed;
by the management server, if a bring-out termination processing time limit is exceeded, and there is a brought out asset brought in from the outside of the management area, sending a caution mail; and
if the bring-out termination processing time limit is exceeded, and there is a brought out asset not brought in from the outside of the management area, sending an alarming mail.

23. A brought out asset, comprising:
an encryption determining unit that determines whether or not encryption processing has been executed on the brought out asset of which bring-out to the outside of a management area is managed by a managing system; and
a brought out information registering unit that registers brought out asset information in the managing system if the encryption processing has been executed on the brought out asset.

24. A computer readable medium embodying a program,
wherein the program causing a brought out asset of which bring-out to the outside of a management area is managed by a managing system to perform a method, the method comprising:
determining whether or not encryption processing has been executed on the brought out asset; and
registering information of the brought out asset in the managing system if the encryption processing has been executed on the brought out asset.

25. An asset bring-out management system comprising:
a brought out asset;
managing system means for managing bring-out of the brought out asset to the outside of a management area;
encryption determining means for determining whether or not encryption processing has been executed on the brought out asset; and
brought out information registering means for registering information of the brought out asset in a managing system if the encryption processing has been executed on the brought out asset.

26. A brought out asset, comprising:
encryption determining means for determining whether or not encryption processing has been executed on the brought out asset of which bring-out to the outside of a management area is managed by a managing system; and
brought out information registering means for registering information of the brought out asset in the managing system if the encryption processing has been executed.
